(19) United States
(12) Patent Application Publication
(10) Pub. No.: US 2007/0102574 A1
(43) Pub. Date: May 10, 2007

(54) Securing a vehicle

(75) Inventors: Arnold Frumin, Greenwich, CT (US); Thomas J. Morley, Greenwich, CT (US)

Correspondence Address: Jeffrey Jacobs;Suite 300, 12000 Richmond Avenue, Houston, TX, 77082, US

(73) Assignee: ReadMeters, Inc.

(21) Appl. No.: 11/256,705

(22) Filed: Oct. 24, 2005

(51) Int. Cl. B64C 13/16

(52) U.S. Cl. 244/76 R

(57) ABSTRACT

An apparatus for securing a vehicle comprises a sensor and an electronic transmitter. The sensor may be removeably coupled to the vehicle, and may detect a movement of the vehicle. The electronic transmitter, coupled to the sensor, may issue a notification in response to the movement of the vehicle.

### BACKGROUND OF THE INVENTION

Aircraft and other vehicles are stolen at an alarming rate. The theft of an aircraft imposes exorbitant costs not only on the owner, but also on the homeland security infrastructure, which must be concerned with the possibility that the aircraft may be used for possible terrorist activities. Since aircraft may be flown only rarely by their owners, a theft of an aircraft may be undiscovered for a long period of time. Also, since stolen aircraft may be flown great distances quickly, searching for an aircraft that has been stolen can be extremely difficult, if not impossible.

Small personal aircraft are commonly stored in regional airports, often in the countryside or in suburban areas, without the sophisticated monitoring available at larger airports. Many such airports are protected only by a fence that a thief may be able to scale. Providing greater security may be beyond the financial capabilities of the airport staff. A thief who can climb over such a fence may have a long period of time in which to start an aircraft without being discovered. Some smaller airports may have older radar systems, possibly of limited range. A thief who has stolen an aircraft may be able to fly the aircraft beyond a scanning range of whatever radar system the airport may have.

### SUMMARY OF THE INVENTION

In accordance with one aspect of the present invention, an apparatus for securing a vehicle comprises a sensor and an electronic transmitter. The sensor may be removeably coupled to a vehicle, such as an aircraft, and may detect a movement of the vehicle. The sensor may be disabled temporarily by any person of a list of authorized persons (e.g., any owner of the aircraft, maintenance personnel, etc.), or during a time period of a list of authorized time periods (e.g., scheduled maintenance). The electronic transmitter, coupled to the sensor, may respond to any movement of the vehicle beyond a predetermined threshold, and may issue a notification in response to the movement of the vehicle. The notification may be directed to a list of personnel, such as law enforcement personnel, local airport personnel, owner(s) of the aircraft, airport security personnel, homeland security and/or the Federal Aviation Authority, etc.

In accordance with still another aspect of the invention, the electronic transmitter may issue an alert in response to the movement of the vehicle. The alert may be directed to a security officer, who may respond to the alert by investigating whether the aircraft (or other vehicle) has in fact been stolen. The security officer may determine whether the movement exceeds the predetermined threshold, whether the movement is due to an authorized person (such as an owner of the aircraft or maintenance personnel), and whether the movement has occurred at an authorized time (such as scheduled maintenance, or a time for which a flight plan has been filed). The security officer may initiate a notification as appropriate.

In accordance with yet another embodiment of the present invention, the security officer is replaced by a computer system. The computer system includes a receiver that can detect the alert from the transmitter, a database coupled to the receiver that may be used to determine whether the movement is authorized, and at least one telecommunications line for providing the notification via telephone (such as cellular, 802.11b, or wire line) and/or email, website posting, and/or text messaging. Recipients of the notification may determine an appropriate response to the movement of the vehicle.

In accordance with another aspect of the present invention, the apparatus also includes a disabler. The disabler may be used to inhibit or prevent further movement of the aircraft. The disabler may be coupled to an engine, flight stick, steering wheel, pedal, propeller, landing gear wheel, or other part of the aircraft.

Of course, the invention may also be implemented in accordance with aspects of the invention that are not described above. Some of the foregoing features may not be included in all embodiments and aspects of the invention, and other features may be added or substituted from the foregoing without departing from the scope of the invention. Examples of certain features of the invention have been summarized here rather broadly in order that the detailed description thereof that follows may be better understood and in order that the contributions they represent to the art may be appreciated. There are, of course, additional features of the invention that will be described hereinafter and which will form the subject of the claims appended hereto.

### BRIEF DESCRIPTION OF THE DRAWINGS

For detailed understanding of the present invention, references should be made to the following detailed description of an exemplary embodiment, taken in conjunction with the accompanying drawings, in which like elements have been given like numerals.

FIG. 1 is a diagram of an apparatus for securing a vehicle, in accordance with a first embodiment of the present invention.

FIG. 2 is a diagram of a system for securing a vehicle, in accordance with another embodiment of the present invention.

### DETAILED DESCRIPTION OF THE INVENTION

In view of the above, the present invention through one or more of its various aspects and/or embodiments is presented to provide one or more advantages, such as those noted below.

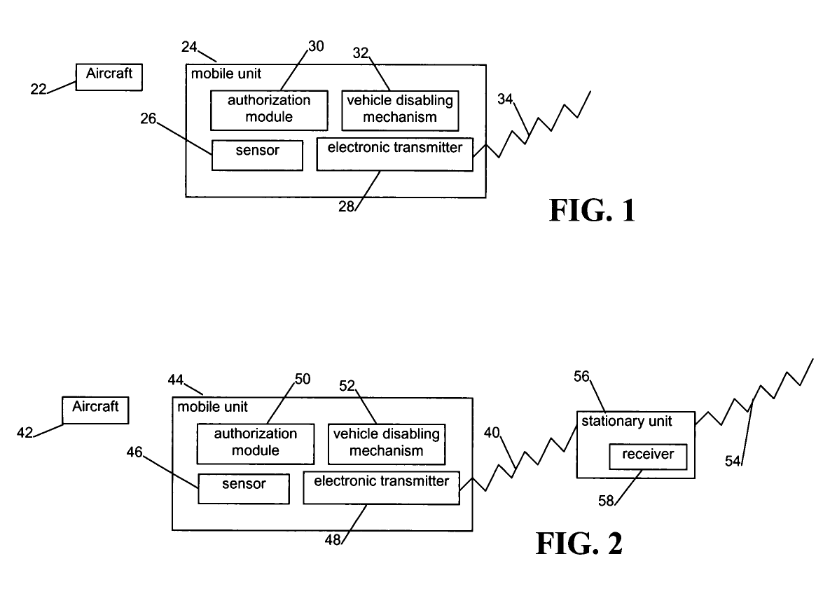

FIG. 1 is a diagram of an apparatus for securing a vehicle, in accordance with a first embodiment of the present invention. The apparatus may be used to secure a vehicle, such as an aircraft 22, automobile, boat, or any other object that may be moved or transported. The apparatus may include a mobile unit 24 that includes a sensor 26, an electronic transmitter 28, an authorization module 30, and a vehicle disabling mechanism 32.

The mobile unit 24 may be removeably coupled to the aircraft 22. For example, the mobile unit 24 may include a hoop that may be hung loosely around a blade of a propeller. Any rotation of the propeller may be sufficient to cause the mobile unit 24 to drop from the propeller onto the ground, a fall of several feet. The mobile unit 24 may be placed at a door to the aircraft 22, or may be placed inside the cockpit of the aircraft 22. The mobile unit 24 may also or alternatively be hidden inside the aircraft 22 such that a thief would have great difficulty finding the mobile unit 24 within the aircraft 22.

In another embodiment of the present invention, the mobile unit 24 may be located within a chock that may be placed adjacent to a landing gear wheel of the aircraft 22. The mobile unit 24 may be such that the aircraft 22 may not be moved unless either the mobile unit 24 is moved or the aircraft 22 rolled over the mobile unit 24.

If desired, the mobile unit 24 may be permanently affixed to the aircraft 22. For example, the mobile unit 24 may be unremoveably built into an electrical system component of the aircraft 22, or may be mounted to the aircraft 22 such that a thief would have great difficulty removing the mobile unit 24 from the aircraft 22. Accordingly, the mobile unit 24 may be welded, glued, bolted, or otherwise attached to the aircraft 22, either within the aircraft 22 or to the exterior of the aircraft 22, and the mobile unit 24 would be moved along with the aircraft 22.

The mobile unit 24 may include a sensor 26. The sensor 26 may be able to detect a movement of the aircraft 22. For example, the sensor 26 may be implemented as an inertial reference sensor, such as an accelerometer and/or gyroscopic sensor. More specifically, the sensor 26 may include a small bob mounted upon one or more springs within a capsule. Any abrupt movement of the mobile unit 24 may be sufficient to cause the bob to make physical contact with the capsule. If a first wire is coupled to the bob and a second wire is coupled to the capsule, the physical contact may complete an electrical circuit, such that the sensor 26 may detect the movement of the aircraft 22.

In another embodiment of the present invention, the sensor 26 may be implemented as a Global Positioning Satellite (GPS) receiver that can determine the location of the aircraft 22. The sensor 26 may determine an initial aircraft location when the sensor 26 is armed, and then may periodically determine a subsequent aircraft location. The sensor 26 may determine if the initial aircraft location differs from the subsequent aircraft location by a distance that exceeds a predetermined threshold.

In accordance with yet another embodiment of the present invention, the sensor 26 may detect a first periodic pulse transmission from a first antenna, and a second periodic pulse transmission from a second antenna. The sensor 26 may then determine a first timing difference between the first periodic pulse transmission and the second periodic pulse transmission. The sensor may periodically thereafter determine a second timing difference. If the first timing difference differs from the second timing difference by more than a predetermined threshold, the sensor 26 may determine that the mobile unit 24 has been moved.

In accordance with yet another embodiment of the present invention, the sensor 26 may detect a pressure applied to a weight sensor. If the pressure exceeds a first predetermined pressure, such as might occur if the aircraft 22 were to roll over the mobile unit 24, the sensor 26 may response as though the mobile unit 24 had been moved.

In accordance with yet another embodiment of the present invention, the sensor 26 may include an emitter and a detector, one of which may be hidden near the aircraft 22 and another of which may be hidden within the aircraft 22. The sensor 26 may be implemented to remain inactive as long as emissions from the emitter remain detected by the detector. If the aircraft 22 were to be moved such that the detector were no longer in range of the emitter, the sensor 26 may determine that the aircraft 22 has been moved.

In accordance with yet another embodiment of the present invention, the sensor 26 may include a detector operative to detect an emission from an antenna maintained by airport personnel. The sensor 26 may be implemented to remain inactive as long as such emissions remain detected by the detector. If the aircraft 22 were to be moved such that the detector were no longer in range of the antenna, the sensor 26 may determine that the aircraft 22 has been moved.

In still another embodiment of the present invention, the sensor 26 may comprise a magnetometer operative to detect a change in proximity of a metal object. In other words, the sensor 26 may detect that it is approaching or receding from the metal object, and/or a magnetometer on the ground may detect that the aircraft 22 is approaching or receding.

The mobile unit 24 may also include an electronic transmitter 28, which may be coupled to the sensor 26. The electronic transmitter 28 may be implemented to issue a notification in response to the movement of the aircraft 22. In accordance with one embodiment of the present invention, the electronic transmitter 28 may include a cellular telephone component that may initiate a conference call among a predetermined list of telephone numbers. The cellular telephone component may broadcast a prerecorded notification message across the conference call to the telephone numbers of the predetermined list of telephone numbers. In accordance with another embodiment of the present invention, the electronic transmitter 28 may include a cellular telephone component that may initiate a sequence of telephone calls, iterating through a predetermined list of telephone numbers. The cellular telephone component may broadcast a prerecorded notification message to each of the telephone numbers of the predetermined list of telephone numbers.

In accordance with yet another embodiment of the present invention, the electronic transmitter 28 may include a cellular telephone component that may be implemented to initiate a telephone call (or a sequence of telephone calls) to a single telephone number. The single telephone number may be associated with airport security personnel, or may be associated with an security officer. A computer telephone integration (CTI) application may obtain an aircraft identification file from a database using, for example, a caller-ID system that receives the telephone call. The aircraft identification file may include a list of instructions for the airport security personnel and/or the security officer to implement, such as a list of telephone numbers to call, including telephone numbers associated with an owner of the aircraft and/or telephone numbers associated with law enforcement personnel. The airport security personnel and/or the security officer may then implement the list of instructions accordingly.

In accordance with one embodiment of the present invention, the mobile unit 24 may also include a vehicle disabling mechanism 32. The vehicle disabling mechanism 32 may be used to inhibit movement of the object. The vehicle disabling mechanism 32 may be engaged automatically or manually each time the aircraft 22 lands. In other words, whenever the engine of the aircraft 22 is turned off, the vehicle disabling mechanism 32 may be engaged. The vehicle disabling mechanism 32 may be engaged automatically each time the aircraft 22 lands, or a pilot may be able to engage the vehicle disabling mechanism 32 manually.

The vehicle disabling mechanism 32 may remain engaged until disengaged. A pilot, maintenance personnel, or others may disengage the vehicle disabling mechanism 32 whenever the authorization module 30 identifies the pilot, maintenance personnel, or others as an authorized person. The vehicle disabling mechanism 32 may also be disengaged automatically during an authorized period of time, such as during scheduled maintenance.

In accordance with one embodiment of the present invention, the vehicle disabling mechanism 32 may include a throttle lock operative to inhibit movement of a throttle control. In accordance with another embodiment of the present invention, the vehicle disabling mechanism 32 may include a wheel lock that inhibits movement of a wheel of the vehicle. In still other embodiments of the present invention, the vehicle disabling mechanism 32 may include engine locks that prevent an engine of the aircraft 22 from operating, an electrical system disabling component that prevents at least one spark plug from firing, and/or a propeller lock that prevents the propeller from turning. Other vehicle disabling mechanisms are also possible.

In another embodiment of the present invention, the vehicle disabling mechanism 32 is not engaged unless a notification is generated. The vehicle disabling mechanism 32 may be coupled to the sensor 26, or may be implemented to detect a call from the electronic transmitter 28.

FIG. 2 is a diagram of a system for securing a vehicle, in accordance with another embodiment of the present invention. The system of FIG. 2 may include an mobile unit 44 that may be used to secure a vehicle, such as an aircraft 42. Like the mobile unit 24 of FIG. 1, the mobile unit 44 of FIG. 2 may include a sensor 46, an electronic transmitter 48, an authorization module 50, and a vehicle disabling mechanism 52. However, the mobile unit 44 differs from the mobile unit 24 of FIG. 1 in that that the electronic transmitter 48 of FIG. 2 need not contain a cellular telephone component. Instead of a cellular telephone component that may initiate a conference call among a predetermined list of telephone numbers, or that may initiate a telephone call (or a sequence of telephone calls) to a single telephone number, the electronic transmitter 48 of FIG. 2 may include a radio transmitter. The radio transmitter may include, for example, a short-range radio frequency (RF) transmitter operative to transmit an alert. The alert may simply be an uncoded signal that is transmitted in response to a movement of the aircraft 42. In accordance with another embodiment of the present invention, the alert may be a signal that includes an aircraft identifier, or may be similar to a “squawk” or transponder signal of the aircraft 42. In accordance with yet another embodiment of the present invention, the radio transmitter is implemented as an additional functionality of the aircraft transponder, which may operate at a lower power level and/or a longer inter-transmission interval when providing the alert.

In accordance with still another embodiment of the present invention, the radio transmitter may be implemented to provide a periodic, sporadic, and/or polled signal, and to assert the alert by suppressing the periodic, sporadic, and/or polled signal. For example, the radio transmitter may be implemented to respond to a polling signal by providing a unique mathematical function of the polling signal. When an alert is asserted, such as when the aircraft 42 is moved, the radio transmitter may suppress any response to the polling signal. The mobile unit 44 may further include a detector that can detect a polling signal from an antenna located at an airport. The detector may be implemented to suppress the alert in response to the polling signal.

In accordance with yet another embodiment of the present invention, the radio transmitter may be able to transmit an alert that contains a sequence of codes that is unique among all similar aircraft, such as might be provided by a pseudorandom number generator having a unique kernel. The sequence of codes may be difficult for a thief to predict, and therefore the thief may be unable to deceive the airport security personnel and/or the security officer simply by placing a substitute transmitter near the aircraft 42.

Accordingly, the alert may be implemented as a signal, or as an absence of a signal. If the alert is implemented as a signal, the signal may be generated asynchronously in response to an unauthorized movement of the aircraft 42, or may be generated synchronously (only while the aircraft 42 has recently been moved without authorization) in response to a polling signal received from an antenna located at the airport. The radio transmitter may be configured to provide to a polling signal with one response algorithm while the aircraft 42 has recently been moved, and with another response algorithm while the aircraft 42 has not recently been moved.

If the alert is implemented as an absence of the signal that is otherwise generated periodically, sporadically, or in response to a polling signal, then the signal may be suppressed in response to a movement of the aircraft 42. In either implementation, the alert may be an uncoded signal, or may be encoded with an aircraft identifier or with other information.

In still another embodiment of the present invention, the electronic transmitter 48 may be configured to transmit a data record for each movement of the aircraft 42, even when such movement of the aircraft 42 is authorized. Accordingly, no notification or alert is generated, but a data record of the movement of the aircraft 42 may be stored. The data record of the movement of the aircraft 42 may include a time stamp, a date stamp, and/or an identification of the authorized person.

In accordance with another embodiment of the present invention, the mobile unit 44 may include an authorization module 50. The authorization module 50 may include a keypad on which a user may enter a code number, such as a personal identification number (PIN). The authorization module 50 may include a biometric sensor, such as a thumbprint scanner and/or a retinal scanner. The authorization module 50 may include a card reader that can read at least one of a magnetic stripe on an ID card, a bar code, and a smart card chip. The authorization module 50 may also or alternately include other mechanisms for limiting authorization to a limited, predetermined list of authorized persons. The authorization module 50 may also include a clock or timer. The clock or timer may be capable of recognizing whether a movement of the aircraft 42 occurs during an authorized time. The authorization module 50 may be capable of suppressing any output of the sensor 46 while the movement of the aircraft 42 is authorized. For example, the authorization module 50 may be capable of disabling the sensor 46, the electronic transmitter 48, or both.

The sensor may be disabled temporarily by any person of a list of authorized persons (e.g., any owner of the aircraft, maintenance personnel, etc.), or during a time period of a list of authorized time periods (e.g., scheduled maintenance). The electronic transmitter, coupled to the sensor, may issue a notification in response to the movement of the vehicle. The notification may be directed to a list of personnel, such as law enforcement personnel, local airport personnel, owner(s) of the aircraft, airport security personnel, homeland security and/or the Federal Aviation Authority, etc.

In accordance with still another aspect of the invention, the electronic transmitter may issue an alert in response to the movement of the vehicle. The alert may be directed to a security officer, who may respond to the alert by investigating whether the aircraft (or other vehicle) has in fact been stolen, and may initiate a notification as appropriate. A computer database coupled to the receiver may be used to determine the list of authorized persons.

The system for securing a vehicle of FIG. 2 may also include a stationary unit 56 located remotely from the aircraft 42. For example, the stationary unit 56 may be permanently located at the airport. In accordance with one embodiment of the present invention, a single stationary unit 56 may be located at each airport, and may service any number of aircraft, including the aircraft 42. In accordance with another embodiment of the present invention, however, a large number of stationary units, including the stationary unit 56, may be implemented at each airport, such that a stationary unit may be dedicated to each aircraft, including the aircraft 42.

The stationary unit 56 may include a receiver 58 that can detect the alert and/or data record of the electronic transmitter 48. The receiver 58 need not be physically coupled to either the aircraft 42. The stationary unit 56 may include a computer system that includes a hard drive, flash drive, random access memory (RAM), floppy drive, tape drive, memory stick, or other mass storage device. The computer system may include a log that includes a log record for each movement of the aircraft 42. If the electronic transmitter 48 provides a signal that includes an aircraft identifier, then the log record may include the aircraft identifier. If the electronic transmitter 48 provides a data record that includes a time stamp, a date stamp, and/or an identification of the authorized person, then the log record may include the time stamp, a date stamp, and/or an identification of the authorized person.

If the radio transmitter is able to transmit an alert that contains a sequence of codes that is unique among all similar aircraft, such as might be provided by a pseudorandom number generator having a unique kernel, then the stationary unit 56 may include either a copy of the sequence of codes or a copy of the kernel to produce an identical copy of the sequence of codes. In another embodiment of the present invention, the vehicle disabling mechanism 52 is not engaged unless an alert is generated. The vehicle disabling mechanism 52 may be coupled to the sensor 46, or may be implemented to detect a transmission from the electronic transmitter 48.

It will be understood that the foregoing description is merely an example of the invention, which is not limited by such description, but rather by the claims and their equivalents. The scope of the disclosure herein also includes any novel feature or any novel combination of features disclosed either explicitly or implicitly or any generalization or modification thereof which would be apparent to persons skilled in the relevant art, and any and all legal equivalents thereof, whether or not such relates to the same invention as presently claimed in any claim and whether or not it mitigates any or all of the same technical problems as confronted by the present invention. The teachings of the foregoing disclosure will suggest other modifications to those persons skilled in the relevant art, including some modifications that may involve other features which are already known and which may be used instead of or in addition to features already described herein. The applicants hereby reserve the right to formulate new claims to such features and/or combinations of such features during the prosecution of the present application or of any further application derived there from.

What is claimed is:

1. A system for securing a vehicle, comprising:
a mobile unit, operative to be removeably coupled to the vehicle, that includes:
a sensor operative to detect a movement of the vehicle, and
an electronic transmitter, coupled to the sensor, the electronic transmitter being operative to issue a notification in response to the movement of the vehicle; and
a stationary unit to receive the notification and, in response thereto, to provide a telephonic notification.

2. The system of claim 1, further comprising:
a vehicle disabling mechanism operative to inhibit movement of the object in response to the movement of the vehicle.

3. The system of claim 2, further comprising:
a disabling mechanism that includes a throttle lock operative to inhibit movement of a throttle control.

4. The system of claim 2, further comprising:
a disabling mechanism that includes a wheel lock that inhibits movement of a wheel of the vehicle.

5. The system of claim 1, wherein:
the sensor comprises a magnetometer operative to detect a change in proximity of a metal object.

6. The system of claim 1, wherein:
the electronic transmitter includes a radio-frequency (RF) transmitter operative to issue a notification to a receiver that is not physically coupled to either the vehicle or the system.

7. An apparatus for securing a vehicle, comprising:
a sensor operative to be removeably coupled to the vehicle, the sensor further operative to detect a movement of the vehicle, and
an electronic transmitter, coupled to the sensor, the electronic transmitter being operative to issue a notification in response to the movement of the vehicle.

8. The apparatus of claim 7, further comprising:
a disabling mechanism operative to inhibit movement of the object in response to the movement of the vehicle.

9. The apparatus of claim 8, further comprising:
a disabling mechanism that includes a throttle lock operative to inhibit movement of a throttle control.

10. The apparatus of claim 8, further comprising:
a disabling mechanism that includes a wheel lock that inhibits movement of a wheel of the vehicle.

11. The apparatus of claim 7, wherein:
the sensor comprises a magnetometer operative to detect a change in proximity of a metal object.

12. The apparatus of claim 7, wherein:
the electronic transmitter includes a radio-frequency (RF) transmitter operative to issue a notification to a receiver that is not physically coupled to either the vehicle or the apparatus.
